(19) United States
(12) Patent Application Publication
(10) Pub. No.: US 2025/0304479 A1
(43) Pub. Date: Oct. 2, 2025

(54) COMPACT DEVICE FOR THE PRIMARY TREATMENT OF INDUSTRIAL WASTEWATER FROM INDUSTRIAL KITCHENS

(71) Applicant: ZHANASOLUTIONS GREEN ENGINEERING SAS, Bogota (CO)

(72) Inventors: Javier Andres De Castro Rodriguez, Bogota (CO); Carlos Andres Paeres Aguirre, Bogota (CO)

(21) Appl. No.: 18/864,185

(22) PCT Filed: May 9, 2023
(86) PCT No.: PCT/CO2023/000005

§ 371 Date: Nov. 8, 2024

(30) Foreign Application Priority Data
May 10, 2022 (CO) NC2022/0006070

(51) Int. Cl. C02F 9/00; B01D 17/02; B01D 17/12; C02F 1/00; C02F 1/02; C02F 1/40; C02F 101/32; C02F 103/32

(52) U.S. Cl. CPC C02F 9/00; B01D 17/0214; B01D 17/12; C02F 1/008; C02F 1/004; C02F 1/02; C02F 1/40; C02F 2101/32; C02F 2103/32; C02F 2201/005; C02F 2209/008; C02F 2209/42

(57) ABSTRACT

The present invention provides a device, system, and process for the primary treatment of wastewater in industrial kitchens, where the main contaminants present in discharges from industrial kitchens are removed in situ from a contaminated aqueous medium. An initial pretreatment is provided, comprising a fine and coarse solid screening zone. Subsequently, the pretreated wastewater undergoes thermal treatment at a controlled temperature (approximately between 40-60° C.) through a heater and/or by conserving the water temperature in various maintenance processes in pot washers, washing trains, ovens, and other wet processes in industrial kitchens. After the thermal treatment, a removal process by adhesion or skimming is performed to remove low-specific-weight substances such as oleophilic substances, floating solids, foams, scum, supernatants, and similar materials.

### TECHNICAL FIELD

The present technology is developed within the environmental industry sector, particularly aimed at providing a device, system, and process for the primary treatment of wastewater in industrial kitchens.

### BACKGROUND OF THE PRESENT INVENTION

Water contamination generated in food preparation processes leads to the loss of ecosystem services in inland water bodies and oceans. In urban areas, water contamination from food processing overburdens public sewage services, causing significant impact on infrastructure with high operational costs for public sewage services.

Currently, in the food industry, wastewater control devices are placed at the end of the pipeline using non-automated and low-efficiency elements for discharge treatment, which increases operational costs for wastewater treatment and creates an unfavorable working environment due to worker exposure to unpleasant odors and septic tasks.

Thus, technologies aimed at improving wastewater treatment in specific environments have been developed in the state of the art. For example, Chinese publication CN113548782 discloses an environmentally friendly municipal wastewater treatment equipment, comprising a barrel and a sludge treatment structure. The bottom wall of the barrel is provided with a discharge port, the side wall of the barrel is embedded with a heating cable, and the top wall of the barrel has an air tube connected to the inner wall of the barrel. The sludge treatment structure includes a rotating barrel with an open top; the upper outer wall of the rotating barrel is positioned on the top surface of the barrel through a bearing. The inner wall of the rotating barrel is fixedly connected with both ends of a cross rod, the center of the cross rod is fixedly connected with the end of a rotating shaft, and the rotating shaft is connected to a driving device. A connecting rod and a plurality of sludge outlet holes are arranged on the spinning barrel wall. The end of the connecting rod is fixedly connected with an arc-surfaced scraper plate, which adheres to the inner side wall of the barrel. The sludge outlet holes are positioned on the arc surface of the spinning barrel opposite the arc-surfaced scraper plate. The centripetal force of the arc-surfaced scraper plate pressing against the barrel's inner wall and the reverse support force provided by the barrel's inner wall for the scraper plate are balanced, and the arc-surfaced scraper plate scrapes the sludge cleanly, thereby preventing the issue of filter screen blockage in a filtration method.

Additionally, Chinese publication CN108203197A refers to a saline wastewater treatment system. The treatment system comprises a circulating pretreatment unit, a circulating reduction unit, and a zero discharge unit. It is characterized by the circulating pretreatment unit, which filters water produced after the high-salt wastewater reacts with pretreatment agents through a tubular microfilter, then discharges the filtered water into the circulating reduction unit. The circulating reduction unit is used for preliminary reduction treatment of the water produced by the circulating pretreatment unit through a reverse osmosis device. A multi-stage electrically driven ionic membrane device, consisting of at least one electrically driven ionic membrane device, is used for deep concentration treatment to further reduce and separate moisture from the high-salt wastewater in a freshwater tank for recycling. A concentrated mixed saline solution obtained through deep concentration is discharged into the zero discharge unit, which is used for heating, evaporating, and crystallizing the concentrated mixed saline solution to recover nitrate and a sodium salt from the concentrated mixed saline solution.

Furthermore, U.S. publication U.S. Pat. No. 6,491,830B1 discloses an oil/grease separation apparatus that includes an inlet section for receiving a liquid flow containing water, oil/grease, and gross solids. The gross solids are separated from the liquid flow and collected in the inlet section. A water jet eductor is provided, having a solids extraction port located at a lower part of the inlet section. The water jet eductor is activated by supplying pressurized water to create a suction to extract accumulated solids from the inlet section. The extracted solids are directed to a separator outlet or an alternative disposal system through suitable piping.

However, the state of the art has not disclosed an automated, appropriately sized device capable of real-time removal of the most common water contaminants in the food industry (fats, oils, lard, organic matter), maximizing the work environment by reducing sanitation tasks in the food preparation process, and lowering costs for industrial wastewater generators, while significantly reducing contaminants in water resources.

### BRIEF DESCRIPTION OF THE DRAWINGS

FIGS. 1 to 4 described below should not be interpreted in a limiting manner, as they only illustrate a preferred embodiment of the invention.

FIG. 1 shows a longitudinal section of the device for the primary treatment of wastewater in the present invention.

FIG. 2 shows a rear cross-section of the device in the present invention, where the wastewater outlet and the sludge and sediment outlet are visible.

FIG. 3 shows a front cross-section of the device in the present invention, where the wash port is visible.

FIG. 4 shows the monitoring and control system of the device in the present invention.

FIG. 5 shows the device of the present invention in use.

### DETAILED DESCRIPTION OF THE INVENTION

The present invention provides a device, system, and process for the primary treatment of wastewater in industrial kitchens, where the main contaminants present in the discharges from industrial kitchens are removed in situ from a contaminated aqueous medium. The invention provides an initial pretreatment that includes a fine and coarse solid screening zone. Subsequently, the pretreated wastewater undergoes a thermal treatment at a controlled temperature (between approximately 40-60° C.) through a heater and/or by maintaining the water temperature in various maintenance processes such as pot washers, washing trains, ovens, and other wet processes in industrial kitchens. After the thermal treatment, an adhesion or skimming removal process is performed to remove low-specific-weight substances such as lipophilic substances, floating solids, foams, scum, supernatants, and similar materials.

In one embodiment of the invention, a device for the primary treatment of wastewater in industrial kitchens is provided, comprising an inlet opening (1) for the entry of wastewater, a screen (2) that retains solids larger than approximately 3.75 mm and allows for the removal of solids from the wastewater, a heater (4) that maintains the wastewater temperature at no more than approximately 60° C., a lifting system (7) that removes low-specific-weight substances by adhesion or skimming, a draining system (8) that channels low-specific-weight substances from the lifting system (7) to a moisture-reducing container (10), a radiofrequency monitoring and control system, a wastewater outlet (12), a washing port (15) that allows potable water to enter for washing sludge and/or sediment accumulated in the device, and a sludge and sediment outlet (14) that removes accumulated sludge and/or sediments from the device.

In a preferred embodiment of the invention, the device for the primary treatment of wastewater also includes a flow reducer (1A) to optimize flow regulation.

In a preferred embodiment of the invention, the device for the primary treatment of wastewater further includes an additional screen (2A) that retains solids between approximately 3.75 and approximately 1 mm, minimizing the size of solids that may remain in the filtered wastewater.

In a preferred embodiment of the invention, the heater (4) is an electric heater.

In a preferred embodiment of the invention, the lifting system (7) consists of a cylinder with a diameter ranging from approximately 80 mm to approximately 120 mm and a height ranging from approximately 190 mm to approximately 230 mm. The cylinder rotates clockwise at speeds from approximately 8 rpm to approximately 12 rpm. The material of the cylinder can be selected from the group comprising stainless steel, Teflon, nylon, high-density polyethylene (HDPE), among other oxidation-resistant materials with high-temperature tolerance.

In a preferred embodiment of the invention, the draining system (8) comprises a plastic blade and a metal channel (9).

In a preferred embodiment of the invention, the device for the primary treatment of wastewater further comprises a wall (6A) for extracting low-specific-weight substances and containing the moisture-reducing container (10). In a highly preferred embodiment of the invention, the wall includes a hollow chamber (10A).

In a preferred embodiment of the invention, the moisture-reducing container (10) includes an overflow from which removed floating substances exit.

In a preferred embodiment of the invention, the radiofrequency monitoring and control system comprises a console (16) that includes a plastic antenna, a control box, and an inspection probe that monitors water level, oil level, and sediment level to notify the system operator of the device's conditions, allowing the device for the primary treatment of wastewater to be turned on or off. In a highly preferred embodiment of the invention, the radiofrequency monitoring and control system operates on 110 V electrical power, is water-resistant, and withstands adverse environmental conditions.

In a preferred embodiment of the invention, the device for the primary treatment of wastewater also includes a dual-valve purge system, allowing easy removal of sediments located in the inclined bottom part, thereby eliminating the presence of heavy solids in downstream sewage networks and their respective consequences.

In another embodiment of the invention, a system for the primary treatment of wastewater in industrial kitchens is provided, comprising a flow reduction device to optimize flow regulation, a pretreatment device that includes a screen (2) that retains solids larger than approximately 3.75 mm and allows solid removal from wastewater, a heating device that maintains the wastewater temperature at no more than approximately 60° C., a lifting device that removes low-specific-weight substances by adhesion or skimming, a draining device that comprises a plastic blade and a metal channel that channels low-specific-weight substances from the lifting device to a moisture-reducing device, and a monitoring and control device.

In a preferred embodiment of the invention, the pretreatment device further includes another screen (2A) that retains solids between approximately 3.75 and approximately 1 mm, minimizing the size of solids that may remain in the filtered wastewater.

In a preferred embodiment of the invention, the heating device is an electric heater (4).

In a preferred embodiment of the invention, the lifting device comprises a lifting system (7) that consists of a cylinder with a diameter ranging from approximately 80 mm to approximately 120 mm and a height ranging from approximately 190 mm to approximately 230 mm. The cylinder rotates clockwise at speeds from approximately 8 rpm to approximately 12 rpm. The material of the cylinder can be selected from the group comprising stainless steel, Teflon, nylon, high-density polyethylene (HDPE), among other oxidation-resistant materials with high-temperature tolerance.

In a preferred embodiment of the invention, the draining device comprises a plastic blade and a metal channel (9).

In a preferred embodiment of the invention, the system for the primary treatment of wastewater further comprises a wall (6A) where low-specific-weight substances are extracted and that contains the moisture-reducing device. In a highly preferred embodiment of the invention, the wall includes a hollow chamber (10A).

In a preferred embodiment of the invention, the moisture-reducing device comprises a moisture-reducing container (10) that includes an overflow where the removed floating substances exit.

In a preferred embodiment of the invention, the monitoring and control device comprises a radiofrequency monitoring and control system that includes a console (16) with a plastic antenna, a control box, and an inspection probe that monitors water level, oil level, and sediment level to notify the operator of the device's conditions, allowing the primary wastewater treatment device to be turned on or off. In a highly preferred embodiment of the invention, the radiofrequency monitoring and control system operates on 110 V electrical power, is water-resistant, and withstands adverse environmental conditions.

In another embodiment of the invention, a primary wastewater treatment process for industrial kitchens is provided, comprising: (i) performing a pretreatment that includes coarse solid screening (greater than approximately 3.75 mm) to remove coarse solids present in the wastewater through a screen; (ii) heating the filtered wastewater to a temperature between approximately 40° C. and approximately 60° C. through a heater when said wastewater reaches an adequate level to perpendicularly contact the axial projection of a low-specific-weight substance lifting system; (iii) removing low-specific-weight substances by adhesion or skimming using the lifting system; (iv) directing low-specific-weight substances to a draining system that carries these substances to a moisture reducer where the floating materials removed will combine with the filtered wastewater from step (ii); and (v) directing the resulting wastewater from steps (ii) and (iii) to an outlet for physicochemical inspection.

In a preferred embodiment of the invention, step (i) of the primary wastewater treatment process is complemented with additional fine solid screening (between approximately 3.75 mm and approximately 1 mm) to minimize the size of the solids.

In a preferred embodiment of the invention, step (ii) of the process takes advantage of the temperature of the incoming wastewater when it is already warm.

The invention enables the water to be directed in a single chamber without baffles or screens, with the aid of flow-directing structures, allowing low-specific-weight contaminants and low water level submergence relative to a perpendicular position of the low-specific-weight substance lifting system to be removed. This substantially reduces the moisture content of the sludge, thereby significantly minimizing its wet weight.

Another advantage of the invention is its capability to remove settleable solids present in pre-rinsing and rinsing processes for pots, cutlery, dishware, glassware, tools, utensils, ovens, and other items in high-load pot washers and industrial kitchens. The sedimentation principle of the device is based on type V sedimentation, typical in clarifier systems, where sludge deposits consist of precipitate concentrations sequentially accumulated over time. The wastewater, free of low-specific-weight substances and solids subject to type V sedimentation (without the aid of coagulants/flocculants), will necessarily pass through the inclined bottom, allowing an additional sedimentation column from the bottom of the device to its outlet. From a small compartment of clarified water, the flow exits the device toward the monitoring system to verify the final water's physicochemical quality. The sludge removed from low-specific-weight substances, after passing through the lifting system, is deposited in the moisture-reducing conductor, where it settles, allowing a secondary separation of water, fats, and oils, enabling this liquid to exit by overflow and gravity to a storage system, free of water, substantially minimizing its wet weight and reducing potential septic effects due to moisture presence.

### BEST METHOD FOR CARRYING OUT THE INVENTION

The device of the invention allows for a primary industrial wastewater treatment process with a capacity of 32 liters, made of 304 stainless steel, designed for a flow rate of 0.7 L/s, in which the main contaminants present in discharges from industrial kitchens, such as chemical oxygen demand (COD), fats, and oils, are removed. Initially, the water is discharged from the point of origin in the industrial kitchen.

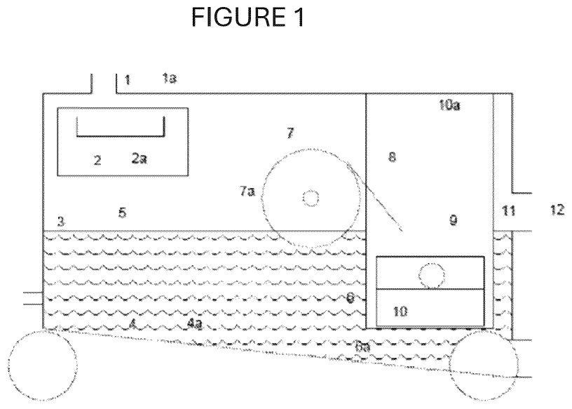

In FIG. 1, we can see the device for primary wastewater treatment, where industrial wastewater enters through an inlet opening (1) made of 304 stainless steel with a diameter of 3.81 mm, male type, with corresponding female-threaded turning, preferably in polyvinyl chloride (PVC), where it must connect with the male thread. To optimize flow regulation, the device includes a flow reducer (1A) to prevent excessive inflow rates. After passing through the inlet opening (1), the next step involves screening or pretreatment of the industrial wastewater through coarse solid screening or solids larger than 3.75 mm using a screen (2) to optimize the removal of large solids that may be discharged during wet processes in industrial kitchens. Pretreatment is also complemented by fine solids screening using an additional screen (2A) with pore sizes ranging from 3.75 mm to 1 mm, minimizing the size of solids that may settle in the sludge section (6).

After pretreating the industrial wastewater, a water level (3) is established, which may fluctuate depending on the inlet flow and corresponding outlet (12). The water level (3) is optimized for perpendicular contact with the axial projection of the low-specific-weight substance lifting system (7). As soon as the water level (3) is established, the industrial wastewater undergoes automated pre-heating at a controlled temperature between 40-60° C., with an electric power of 525 W and voltage of 220V, through an electric heater (4). In some cases, it may be feasible to conserve or utilize the incoming water temperature if hot water is available from a maintenance process, minimizing the need to activate the heater. The heater (4) activation reduces the specific weight of oily substances, causing them to rise in the wastewater column for optimal lifting and removal by the lifting system (7). The heater (4) has an overheat protection system that shuts it off if the temperature exceeds 60° C.

The water flow direction (5) moves from the pretreatment zone to the low-specific-weight substance lifting system (7). The flow direction (5) is oriented by the oscillation of the level at the outlet (12), maintaining a consistent flow path to direct low-specific-weight contaminants to the lifting system (7), while solids filtered by the screen (2) or with type V sedimentation properties due to natural agglutination settle in the wastewater treatment device without the need for baffles or deflectors, as observed in the sludge section (6).

Additionally, a dual-purpose wall (6A) has been included, which can either calm the flow or separate the hollow chamber (10A), which serves as the extraction zone for low-specific-weight substances. A channel with a 10.41% slope is created, ensuring type V sedimentation movement as seen in the sludge section (6). When industrial wastewater comes into contact with the low-specific-weight contaminant lifting system (7), substances such as oleophilic compounds, floating solids, foams, scum, supernatants, among others, are removed by adhesion or skimming. The lifting system (7) has a cylindrical geometry, with a diameter of 100 mm and a height of 210 mm, rotating clockwise at 10 RPM as shown in the lifting path line (7A). The submersion level of the low-specific-weight contaminant lifting system is set at 25% submersion, where the rotation axis remains above the water level (3), making it difficult to collect water in the separated contaminant.

Oleophilic substances, floating solids, foams, scum, supernatants, and others come into contact with the rotating cylinder, which rotates clockwise and contacts a plastic blade attached to a metal channel (9) made of 304 stainless steel, as seen in the draining system (8). The draining system is 90 mm high and 210 mm long, consisting of a plastic blade adhered to the metal channel (9), which channels low-specific-weight contaminants to a moisture-reducing container (10). The moisture-reducing container (10) functions by density, meaning that the removed floating materials exit from the surface part of the container, corresponding to a circular overflow with a diameter of 253 mm. The hollow chamber (10A) for moisture reduction and the draining system (8) are shown in FIG. 1.

Finally, the clarified water, after removal in the sludge section (6) and along the lifting path line (7A), will pass through the inclined bottom section, which allows an additional sedimentation column (11) from the bottom of the device to the outlet (12), through a 20 mm wide and 360 mm long compartment, where clarified water is directed toward the inspection valve for verification of the final water's physicochemical quality.

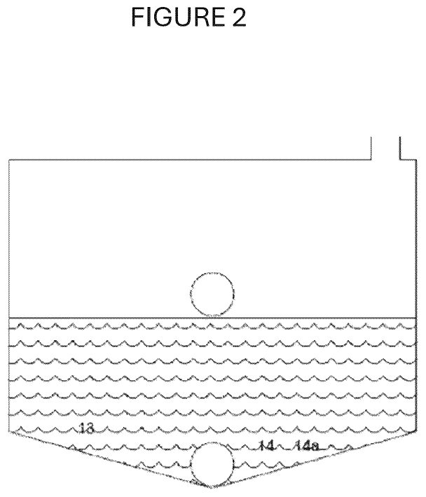

Over time, the device accumulates sediments from the pretreatment screening in screen (2) or due to type V sedimentation properties from natural agglutination, with sediments depositing in both the sludge section (6) and the inclined front spaces (13; 14A) (see FIG. 2), which have a transverse slope of 32.25%, optimized for high solid load sedimentation under type V sedimentation effects. The longitudinal and transverse sedimentation zones in the device connect directly to the outlet system so that accumulated sediments can be discharged through the solids and sediments outlet (14), ensuring that the device does not discharge accumulated sediments into final industrial wastewater networks and avoiding future clogging.

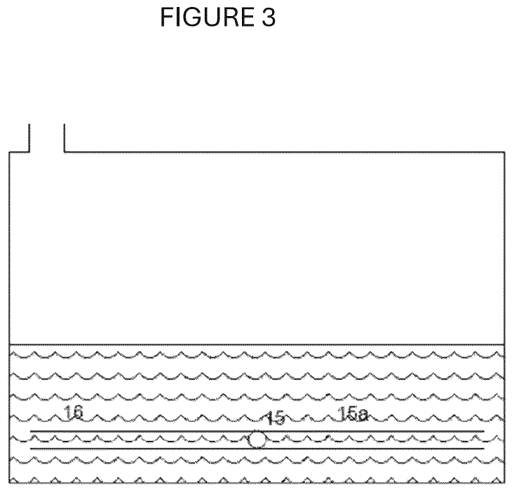

A key advantage of the device is that it is very easy to clean and maintain, with a 231 mm washing port (15) that can connect to potable water systems, distributing the liquid to the bottom of the device, as seen in FIG. 3, providing a quick and easy method for evacuating sludge and sediments through the solids and sediments outlet (14) (see FIG. 2). The initial pretreatment through screen (2; 2A) is non-invasive and does not require opening the device, making maintenance quick and easy.

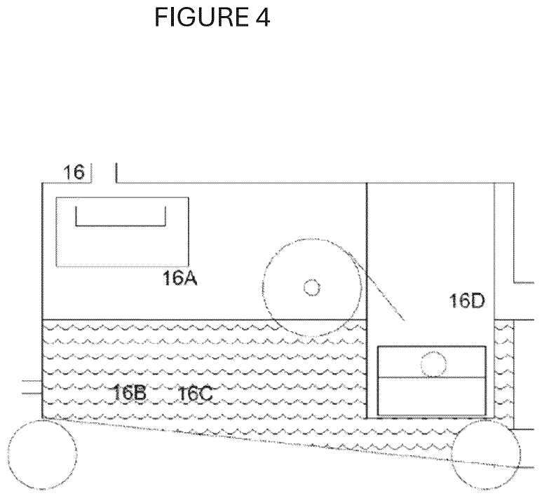

FIG. 4 shows the monitoring and control system with radio frequency, allowing the device to be turned on or off via signals sent by the monitoring and control system. The monitoring and control system operates on 110V electrical power, is water-resistant, and withstands adverse environmental conditions. The console (16) has a plastic antenna, a control box, and an inspection probe that monitors water level, oil level, sediment level, notifying the system operator and enabling the device to be turned on or off. As shown in FIG. 4, the monitoring and control system probe allows the device to be controlled by checking the water level (3); if the water level is not optimal for device operation, a shutdown signal is sent to protect the integrity of the heater (4) via the emitted signal (16A). The data collected by the console (16) allows the user to gather statistical data such as water level (3), type V sediment level (16B) in the sludge section (6), grease level (16D) that may escape into the wastewater outlet (12), and monitor the water heater (16C).

Table 1 shows the control matrix of the devices monitoring and control system:

TABLE 1

| Assigned Sensor | Automated Function | Signal Interpretation |
|---|---|---|
| 16A | On/Off | If the water level is not |
| | | optimal, the device shuts |
| | | down. |
| 16B | Heater Shutdown | If the water temperature |
| | | exceeds 60° C., only the |
| | | heater shuts down, while |
| | | other functions remain |
| | | operational. |
| 16C | Silt Detection | If there is a high presence |
| | | of silt and sediments |
| | | requiring emergency |
| | | maintenance, a reminder |
| | | signal is sent via a |
| | | SCADA system to users. |
| 16D | Grease Detection in | If there is a high presence |
| | Sewage | of grease in the sewage, |
| | | a signal is sent to activate |
| | | the heater (4) and the |
| | | lifting system (7) to initiate |
| | | an emergency treatment |
| | | cycle, different from the |
| | | initial programming. |

TABLE 2
Table 2 shows an efficiency matrix of the device in different locations labeled
A1, A2, and A3:

| | | | | | | Grease | COD |
|---|---|---|---|---|---|---|---|
| | | Grease | Grease | COD | COD | Removal | Removal |
| | Flow | Inlet | Outlet | Inlet | Outlet | Efficiency | Efficiency |
| Location | (L/day) | (mg/L) | (mg/L) | (mg/L) | (mg/L) | (%) | (%) |
| A1 | 389 | 6.435 | 203 | 31.854 | 3.086 | 96.85% | 90.31% |
| A2 | 222 | 18 | 122 | 12.288 | 389 | 99.32% | 96.83% |
| A3 | 544 | 2.757 | 93 | 1.946 | 410 | 96.63% | 78.93% |
| A4 | 541 | 2.218 | 145 | 12.902 | 3.584 | 93.46% | 72.22% |

1. A device for the primary treatment of wastewater in industrial kitchens comprising:
an inlet opening (1) for the entry of wastewater;
a screen (2) that retains solids larger than 1 mm;
a heater (4) that maintains the wastewater temperature at no more than 60° C.;
a lifting system (7) that removes low-specific-weight substances by adhesion or skimming;
a draining system (8) that channels low-specific-weight substances from the lifting system (7) to a moisture-reducing container (10);
a radiofrequency monitoring and control system;
a wastewater outlet (12);
a washing port (15) that allows potable water entry for washing sludge and/or sediment accumulated in the device; and
a sludge and sediment outlet (14) that removes accumulated sludge and/or sediments from the device.

2. The device according to claim 1, wherein the device further comprises a flow reducer (1A) to optimize flow regulation.

3. The device according to any of the preceding claims, wherein the heater (4) is an electric heater.

4. The device according to any of the preceding claims, wherein the lifting system (7) consists of a cylinder.

5. The device according to any of the preceding claims, wherein the material of the cylinder can be selected from the group comprising stainless steel, Teflon, nylon, high-density polyethylene (HDPE), among other oxidation-resistant and heat-tolerant materials.

6. The device according to any of the preceding claims, wherein the draining system (8) comprises a plastic blade and a metal channel (9).

7. The device according to any of the preceding claims, wherein the device further comprises a wall (6A) for extracting low-specific-weight substances and containing the moisture-reducing container (10).

8. The device according to any of the preceding claims, wherein the wall comprises a hollow chamber (10A).

9. The device according to any of the preceding claims, wherein the moisture-reducing container (10) includes an overflow from which removed floating substances exit.

10. The device according to any of the preceding claims, wherein the radiofrequency monitoring and control system comprises a console (16) that includes a plastic antenna, a control box, and an inspection probe that monitors water level, oil level, and sediment level.

11. The device according to any of the preceding claims, wherein the device further comprises a dual-valve purge system.

12. A system for the primary treatment of wastewater in industrial kitchens comprising:
a flow reduction device to optimize flow regulation;
a pretreatment device that includes a screen (2) that retains solids larger than 1 mm;
a heating device that maintains wastewater temperature at no more than 60° C.;
a lifting device that removes low-specific-weight substances by adhesion or skimming;
a draining device that comprises a plastic blade and a metal channel that channels low-specific-weight substances from the lifting device to a moisture-reducing device; and
a monitoring and control device.

13. The system according to claim 12, wherein the heating device is an electric heater (4).

14. The system according to any of the preceding claims, wherein the lifting device comprises a lifting system (7) that consists of a cylinder.

15. The system according to any of the preceding claims, wherein the material of the cylinder is selected from the group comprising stainless steel, Teflon, nylon, high-density polyethylene (HDPE), among other oxidation-resistant and heat-tolerant materials.

16. The system according to any of the preceding claims, wherein the draining device comprises a plastic blade and a metal channel (9).

17. The system according to any of the preceding claims, wherein the system further comprises a wall (6A) for extracting low-specific-weight substances and containing the moisture-reducing device.

18. The system according to any of the preceding claims, wherein the wall comprises a hollow chamber (10A).

19. The system according to any of the preceding claims, wherein the moisture-reducing device comprises a moisture-reducing container (10) that includes an overflow from which removed floating substances exit.

20. The system according to any of the preceding claims, wherein the monitoring and control device comprises a radiofrequency monitoring and control system that includes a console (16) with a plastic antenna, a control box, and an inspection probe that monitors water level, oil level, and sediment level.

21. A primary wastewater treatment process in industrial kitchens comprising the steps of:
(i) performing a pretreatment that includes coarse solid screening of solids larger than 1 mm to remove coarse solids present in the wastewater using a screen;
(ii) heating the filtered wastewater to a temperature between 40° C. and 60° C. using a heater;
(iii) removing low-specific-weight substances by adhesion or skimming using a lifting system;
(iv) directing low-specific-weight substances to a draining system that channels these substances to a moisture reducer, where the removed floating materials combine with the filtered wastewater from step (ii);
(v) directing the wastewater from steps (ii) and (iii) to an outlet for physicochemical inspection.

22. The process according to claim 21, wherein in step (ii) the temperature of the incoming wastewater is optionally utilized if it is already warm upon entry.
